(19) United States
(12) Patent Application Publication
(10) Pub. No.: US 2026/0074641 A1
(43) Pub. Date: Mar. 12, 2026

(54) SELF-GEN GENERATOR ECONOMICS ELECTRIC (S-GEE)

(71) Applicant: Yoksuriya AKARASARUTIPONG, Bangkok (TH)

(72) Inventor: Yoksuriya AKARASARUTIPONG, Bangkok (TH)

(21) Appl. No.: 18/882,818

(22) Filed: Sep. 12, 2024

(51) Int. Cl. H02P 27/06; H02K 7/116

(52) U.S. Cl. CPC H02P 27/06; H02K 7/116

(57) ABSTRACT

The Self-Gen Generator Economics Electric (S-GEE) comprises key components: an electric motor producing torque, a fire boxing torque amplifier, a generator producing current, a current converter, a smart meter controlling the converter, a dummy load, battery backup, motor speed controls (VFD) supplying power to the motor, reverse current protection, and an automatic power switch. The switch transitions between the battery's startup power and the machine's self-generated renewable energy. “Self-Gen” refers to this self-generated power, while “Economies Electric” refers to low-cost electricity derived from a fire boxing torque booster that enhances torque beyond the generator's capacity, maximizing energy efficiency.

### FIELD OF THE INVENTION

Mechanical engineering related to motors, gears and power transmission shafts. Electrical engineering related to generators and electrical control systems.

### BACKGROUND

Electricity is an important factor in driving the global economy and is essential for daily and economic development. However, the demand for electricity has led to problems related to the climate change. Various countries have attempted to build large dams to generate electricity however a study by the National Institute of Space Research of the Brazilian government found that dams are the largest sauries of methane emissions (FIG. 3 No.57), accounting for 23% of methane produced by human activity. Methane is produced when dams alter the flow of water and create stagnant water where sediments and plant debris accumulate. This eventually leads to large-scale methane production. In addition, dams also emit carbon dioxide (CO2) during construction, where many studies have not taken this effect into account.

Nuclear power generation produces large amounts of toxic waste, and there is no government has yet found a safe way to dispose of it. Some nuclear wastes have extremely high radiation levels and will continues to emit radiation for thousands of years. This nuclear waste poses a significant threat to the global environment and future generations who will be responsible for managing the waste for centuries.

There is currently no method of power generation that is completely free of negative environmental impacts. Although, tremendous effects have been made to develop and utilize new energy sources, no natural energy source has been completely controllable by man. Every year our world faces an energy crisis. As result, global energy trends are shifting towards clean energy to counteract climate change. However, there are limitations such as some energy sauries are not continuously available—for example, solar energy cannot be generated at night and wind turbines require wind, which is not always available. Some types of energy are also location-dependent—for example, geothermal energy. In general, the field of clean energy production faces underlying issues which may lead to uncertainly and unresolved problems.

The economics of power generator is the sustainable solution to the world's energy problems. It is about creating a mechanism to fully control natural forces which led to the invention of the self-Rotation Generator (Self-Gen) the principle of the self power generation system is to increase the mechanical torque of the electric motors to be several times more than the mechanical torque of power generators. The electric motor consumes only a small amount of electrical power (KW), but it can generate a large amount of electrical energy when required. This control is achieved through the good design, resulting in cheap electricity” that is available to people all over the world as a universal energy wave. Some of the electricity generated is fed back into the motor to keep the system running and producing power continuously. The utilization of the remaining energy results in “Self-sustaining, low-cost electricity” that helps the solve economics problems, to improve quality of life and restore the global environment without depleting other natural resources.

The key to the success of the self-gen power generation system lies in the torque-boosting mechanism, known as, “fire-boxing,” which converts the input torque into a much higher output torque. To do this, the equation T=F*R must be used, where T=Torque (Nm), F=applied force and R=total radius of the auxiliary wheels (m). The value of R is increased by adding auxiliary gears 28 (as shown in FIG. 2). The torque (T) increases, multiplicatively for each set of years. If several sets of gears are used in succession, the resulting torque increases exponentially and is sufficient to overcome the torque of the generator when it is calculated to the corresponding values.

### Nature and Purpose of the Invention

This invention aims to generate electricity without relying on external energy sources and is known as self-Gen Generator Economics Electric (S-GEE).

The one goal of this invention is to change the conventional economics of electricity generation, including method, techniques and production casts, to achieve “Self-sufficient, low-cost electricity. “This would become the main driving force for improving the economy, improving the quality of life, and restoring the environment for the global community.

Another goal of this invention is to develop the “Fire-Boxing torque-enhancing mechanism”, which is the centerpiece of the Self-Gen power generation system. This mechanism converts other forms of mechanism energy—such as that from wind turbines, water turbines and motors-into the mechanical energy of the fire boxing (as shown in FIG. 3, No.33).

The ultimate goal of this invention is to make the Self-Gen Generator Economics Electric (S-GEE) a tool that facilitates collaborations between organizations to create a global network that aims to reduce carbon dioxide (CO2) emissions by a factor of five compared to the emissions generated by the construction of dams to generate electricity (as shown in FIG. 3, No.34).

Another advantage of this invention is the application of the fire boxing torque amplification mechanism to other mechanical power transmission system, thereby improving their efficiency.

### BRIEF DESCRIPTION OF DRAWINGS

FIG. 1: A schematic representation of the Self-Gen Generator Economics Electric (S-GEE).

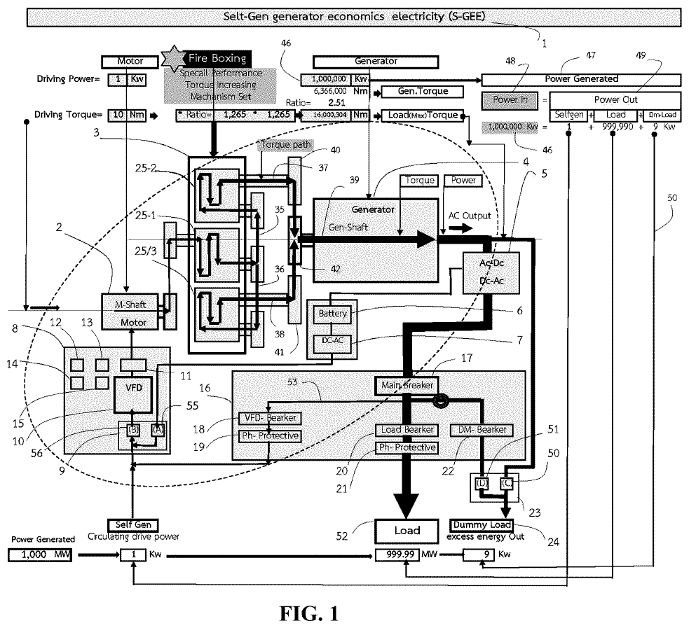

FIG. 2: The illustration of the principle of torque transmission by the fire boxing.

FIG. 3: A comparison of power generation units in term of CO₂ reduction between dam-based power generation and Self-Gen Generator Economics Electric (S-GEE)

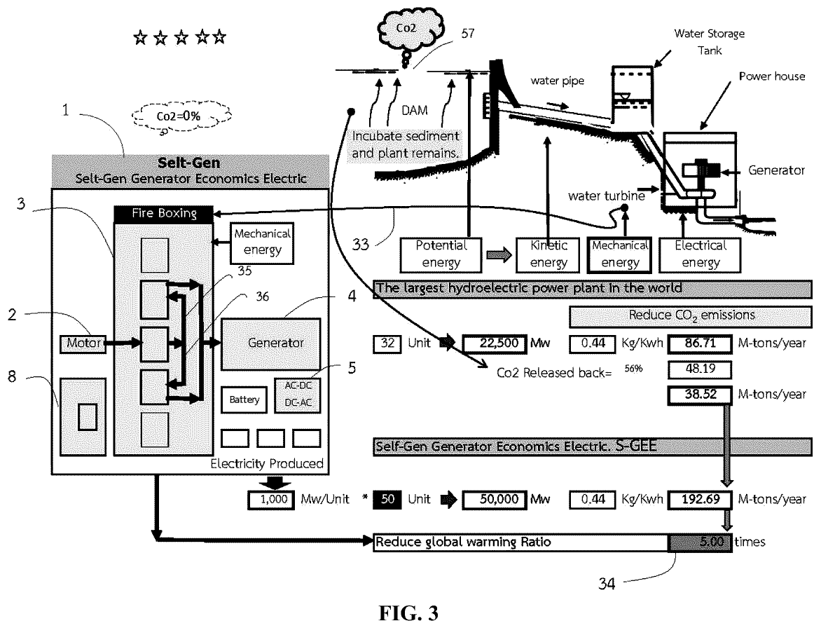

### DETAILED DESCRIPTION OF THE INVENTION

The detailed aspects of the invention will become apparent from the following description, which refer to the figures and its corresponding component numbers.

### The Component and Functions of the Individual Parts

The Self-Gen Generator Economics Electric (S-GEE) 1. Consists of the main components: Electric motor 2. Serves as a drive motor and generates torque, the fire boxing torque transmission mechanism 3. Amplifies the generated torques, generator 4. Generates electricity, current converters. 5. Converts alternation current (AC) to direct current (DC) and converts direct current (DC) into alternating current (AC), thus ensuring a constant and usable current output battery storage, 6. Stores reserve electricity, DC-AC converter for battery converts the output current to AC, 7. And feeds to VFD for a next start control switchboard. 8. Manages the entire system, including: Automatic transfer switch 9. Switches the power supply of the VFD, VFD=vary Frequency Drive 10: The backflow preventer prevents current from flowing back from the electric motor into the VFD 11: Power meter 12: supply-load meter 13: dummy load meter 14: smart meter, to control the power converters; to supply the load accordingly. 15: Power supply controller 16: Includes the main circuit breaker 17: the VFD breaker 18: which control the power supply to the VFD, (Phase Protection Device) 19: load-breaker 20: Current Protective Device 21: for the load, overcurrent circuit breaker, 22: automatic transfer switch 23: Dummy load 24: The Fire Boxing torque Enhancement Mechanism 3.consists of: an external structural housing for mounting internal components 25: the first main gear (1) acting as a drive gear 26: the second main gear (2) acting as a driven gear 27: a helper gear 28: for mechanical force enhancement, a driving shaft 29: a driven shaft 30: a shaft of the helper gear 31: bearing embedded in the helper gear 32,

### The Operation of the Components

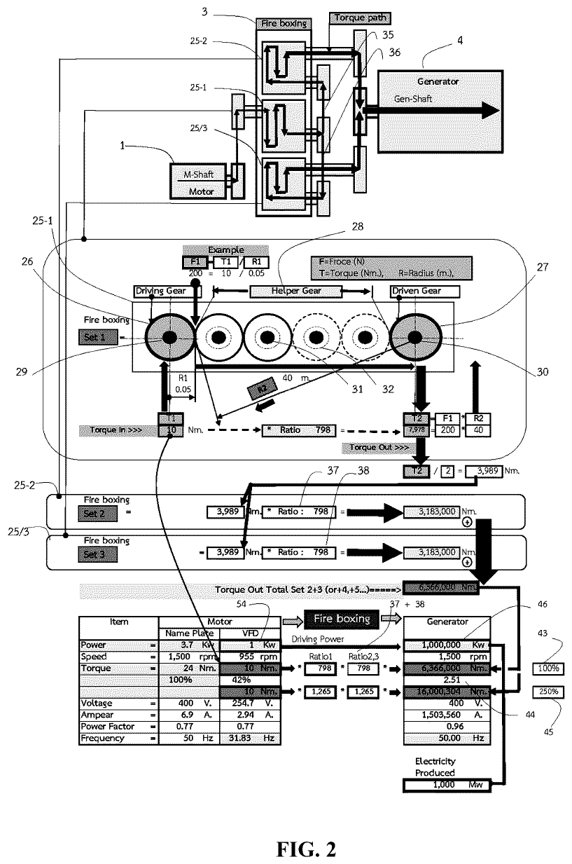

The operation of the “Self-Gen Generator Economics Electric (S-GEE) 1. Begins when the system is switched on, where current is fed from the battery 6.via the DC-AC converter 7.and the automatic transfer switch 9. To supply the VFD 10. Which controls the motor speed. The current supplied to the motor must flow through the backflow preventor. 11. When the motor (2) starts to generate torque, it drives the mechanism to increase the torque in the fire boxing (3) The first fire boxing set (25/1) amplifies the torque several times over and posses it on to the second fire boxing (25/2) and the third (25/3) fire boxing sets. The torque is divided into two parts (35, 36) each of which is further amplified according to the desired ratio 37, 38. The combined torque is then transmitted to the generator shaft 39.where two gears (40, 41) drive the gear of a generator. 42 When the transmitted torque equals to 100% of the generator's production capacity (as show in FIG. 2, No.43), 44 an additional margin of 2.5 times or 250% of the torque is added to ensure that the engine does not require higher drive power 54.

If the “Self-Gen Generator Economics Electric (S-GEE) 1. Generates power at 100% of its capacity 46. The generated power 47. May fluctuate if the power in 48. Do not correspond to the power out 49. The excess energy must therefore be dissipated via two paths. The first path leads directly from the generator as the main current flow through the magnetic(C) 50 if no load is applied, most of the energy flows via this path. The second path takes over the remaining energy after supplying the load 52 which has passed through the power converter (5) and serves as a reserve current that flows through Magnetic 51. To the Dummy load 24. In order to stabilize the power fluctuation of the system.

In order to operate the Self-Gen system autonomously, a portion of the energy along the path number 53 with-a small kw value 54 (FIG. 2) is fed back to the electric motor (2) to maintain continuous operation. The starting power is switched back via the Magnetic (A) 55 to utilize the self-generated energy circulating within the system via the Magnetic (B) 56 completing the operating cycle.

### The Best Method for the Invention

Is that describe in the full disclosure section of the invention.

What is claimed is:

1. “Self-Gen Economics Electric Generator” consisting of an electric motor that serves as a prime moves to generate torque; at least one “Fire Boxing” Torque Amplification Mechanism, a critical component; a generator that produces electricity; an AC-DC and DC-AC converter; a battery storage system for backup power; a DC to AC converter that supplies power to the variable frequency drive (VFD) to start the system; an automatic power source switch that switches between the starting current and the Self-Generated current so that the system can run autonomously without relying on external energy sources; a VFD to control the speed of the electric motor; and a reverse power protection device that prevents feedback from the electric motor to the VFD.

2. A Fire Boxing Torque Amplification Mechanism” (1.set) composing: an external structural housing for housing various internal components; two main gears attached to the input and output shafts, characterized in that it has at least one “helper gear (28) that boots power by rotation around the shaft with an embedded bearing connection the two main gears.

3. The Self-Gen Generator Economics Electric, according to claim 1, wherein the electric motor is replaced by another device as prime mover comprising the elements according to claim 2.

4. The Self-Gen Generator Economics Electric, according to claim 1, wherein the generator is replaced by another device serving as on power generator and comprising the elements according to claim 2.

5. The “Fire Boxing Torque Amplification Mechanism” of claim 2, wherein the outer structural box is replaced by another structure to hold the various internal components.

6. Another type of generator which comprising one of the elements of claim 2 to 4.

7. Another type of mechanic system which comprising the elements of claim 2.
